(19) United States
(12) Patent Application Publication
(10) Pub. No.: US 2015/0378126 A1
(43) Pub. Date: Dec. 31, 2015

(54) MID-SPAN BUFFER SHAVING TOOL

(71) Applicant: RIPLEY TOOLS, LLC, Cromwell, CT (US)

(72) Inventors: Orelvis Migenes, Cromwell, CT (US); Michael Swol, Cromwell, CT (US)

(21) Appl. No.: 14/767,713

(22) PCT Filed: Jun. 12, 2014
(86) PCT No.: PCT/US14/42037

§ 371 Date: Aug. 13, 2015

Related U.S. Application Data
(60) Provisional application No. 61/834,190, filed on Jun. 12, 2013.
(60) Provisional application No. 61/880,208, filed on Sep. 20, 2013.

(51) Int. Cl. G02B 6/44

(52) U.S. Cl. CPC G02B 6/4497

(57) ABSTRACT

A tool for accessing an optical fiber within a buffer tube comprising a buffer tube guide having a groove for insertion of a buffer tube and a blade movable from a first position away from the buffer tube guide to a second position against the buffer tube guide. The tool may include a lower body section and an upper body section movable toward and away from the lower body section, the blade attached to the upper body section and the buffer tube guide attached to the lowered body section wherein the blade contacts the buffer tube when the upper body section is toward the lower body section. The buffer tube guide may be removably securable to the lower body section and the buffer tube guide is replaceable with at least one different sized buffer tube guide for insertion of at least one different sized buffer tube.

This application claims priority to U.S. Application No. 61/834,190, filed Jun. 12, 2013 and U.S. Application No. 61/880,208, filed Sep. 20, 2013.

### BACKGROUND OF THE INVENTION

1. Field of the Invention

The present invention is directed to a shaving tool and method for accessing an optical fiber within a buffer tube.

2. Description of Related Art

Fiber optic cables employ a buffer tube to encapsulate one or more optical fibers for mechanical isolation, protection from physical damage and fiber identification. There are instances where the optical cable must be accessed within the buffer tube at a location along the cable that prevents removing the buffer tube from the end of the cable. Mid-span access is further complicated by the fact that the optical cable cannot be scratched, chipped, cracked or otherwise modified from its original shape and condition. A tool for neatly accessing the fiber optic cable mid-span within a buffer tube is needed.

### SUMMARY OF THE INVENTION

Bearing in mind the problems and deficiencies of the prior art, it is therefore an object of the present invention to provide a shaving tool and method for accessing an optical fiber within a buffer tube to create a mid-span access opening in fiber optic buffer tubes without damaging fibers.

It is another object of the present invention to provide a shaving tool and method that compensates for out-of-round buffer tubes.

A further object of the invention is to provide a shaving tool and method that eliminates the need for tool or thumbscrew to change guide size.

It is yet another object of the present invention to provide a shaving tool and method that keeps the tool in open position to make tube loading quick and easy.

Another object of the present invention is to provide a shaving tool and method that keeps the tool in locked position during use.

A further object of the invention is to provide a shaving tool and method with a blade design that creates smooth cutting action of the buffer tube without disturbing or damaging the underlying fibers.

An object of the invention is to provide a shaving tool in which there is no need for the operator to adjust the setting of the blade.

The above and other objects, which will be apparent to those skilled in the art, are achieved in the present invention which is directed to a buffer tube shaving tool for accessing an optical fiber within a buffer tube comprising a buffer tube guide having a groove for insertion of a buffer tube and a blade movable from a first position away from the buffer tube guide to a second position against the buffer tube guide. The buffer tube shaving tool may include a lower body section and an upper body section movable toward and away from the lower body section, the blade attached to the upper body section and the buffer tube guide attached to the lower body section wherein the blade contacts the buffer tube when the upper body section is toward the lower body section. The buffer tube guide may be removably securable to the lower body section and the buffer tube guide is replaceable with at least one different sized buffer tube guide for insertion of at least one different sized buffer tube. The buffer tube shaving tool may include a tension spring which urges the upper body section to a position toward the lower body section and a cam which urges the upper body section away from the lower body section. The buffer tube shaving tool may include a cam having a pivot attached to one end of the tension spring, the opposite end of the tension spring attached to the lower body section wherein in a first cam position the upper body section is allowed to move away from the lower body section and in a second cam position, the cam provides tension on the tension spring, urging the upper body section toward the lower body section. The buffer tube shaving tool may include an oval cam having a short diameter, a long diameter, a pivot positioned perpendicular to the short diameter and the long diameter; a cam lever attached to the cam for rotating the cam between a horizontal direction wherein the short diameter extends between the upper body section and the lower body section and a vertical direction wherein the long diameter extends between the upper body section and the lower body section and wherein the cam is secured to the upper body section; and a tension spring attached at one end to the cam and at the opposite end to the lower body section, the tension spring urging the upper body section to a position toward the lower body section when the cam is in the vertical direction. The buffer tube shaving tool may include at least one guide rod slidingly disposed at one end in an upper body section opening and at the opposite end in a lower body section opening whereby the upper body section remains parallel to the lower body section as the upper body section moves toward or away from the lower body section. The buffer tube shaving tool may include a plunger on the upper body section which when the upper body section is toward the lower body section, contacts the buffer tube, slidably securing the buffer tube in the groove. The buffer tube shaving tool may include a plunger holder and a plunger spring disposed in an elongated opening in the plunger holder, the plunger disposed against the plunger spring wherein the plunger is urged against the buffer tube by the plunger spring. The buffer tube shaving tool may include a cam lever attached to a cam, the cam lever movable from a first position wherein the upper body portion is disposed away from the lower body portion to a lockable second position wherein the upper body portion is disposed against the lower body portion. The buffer tube shaving tool may include a blade holder for securing the blade in either the blade first position or the blade second position. The buffer tube shaving tool may include a blade holder for securing the blade on the upper body section.

Another aspect of the present invention is directed to a buffer tube shaving tool for accessing an optical fiber within a buffer tube, the buffer tube shaving tool comprising a lower body portion, an upper body portion slidingly attached to the lower body portion, a compression spring between the lower body portion and the upper body portion biasing the upper body portion away from the lower body portion and a cam lever attached to a cam, the cam lever movable from a first position wherein the upper body portion is disposed away from the lower body portion to a lockable second position wherein the upper body portion is disposed against the lower body portion. The buffer tube shaving tool includes a buffer tube guide removably attached to the lower body portion, the buffer tube guide having a groove for placement of a buffer tube therein and a blade disposed on the upper body portion, the blade including a cutting surface disposed at an angle against the buffer tube guide when the cam lever is in the second position and disposed away from the buffer tube guide when the cam lever is in the first position. The buffer tube shaving tool may include a plunger disposed on the upper body portion biased against the buffer tube guide channel when the cam lever is in the second position. The buffer tube is axially slidable along the groove when the buffer tube is placed in the groove and the blade shaves a portion of the buffer tube when the cam lever is in the second position and the buffer tube is slid along the groove. The buffer tube shaving tool may include a tension spring attached at one end to the cam and at the opposite end to the lower body section, wherein the cam is secured to the upper body section, the tension spring urges the upper body section to a position toward the lower body section and the cam, when rotated to the second position, overcomes the tension spring bias to position the upper body section toward the lower body section.

Another aspect of the present invention is directed to a method for accessing an optical fiber within a buffer tube comprising providing a buffer tube guide having a groove for insertion of a buffer tube and a blade movable from a first position away from the buffer tube guide to a second position against the buffer tube guide, providing a buffer tube having an optical fiber therein and ensuring the blade is in the first position away from the buffer tube guide and placing the buffer tube in the groove of the buffer tube guide and moving the blade to the second position against the buffer tube guide. The method includes sliding the buffer tube in the groove until a portion of the buffer tube has been removed by the blade, moving the blade to the first position away from the buffer tube guide and removing the buffer tube from the buffer tube guide. The method may include providing a lower body section and an upper body section movable toward and away from the lower body section. The blade is attached to the upper body section and the buffer tube guide is attached to the lower body section wherein the blade contacts the buffer tube when the upper body section is toward the lower body section. The step of ensuring the blade is in the first position away from the buffer tube guide includes ensuring that the upper body section is in the position away from the lower body section and the step of moving the blade to the first position away from the buffer tube guide includes moving the upper body section away from the lower body section. The method may include providing a compression spring which urges the upper body section to a position away from the lower body section, providing a cam which urges the upper body section toward the lower body section and ensuring that the upper body section is in the position away from the lower body section is accomplished by ensuring the cam is rotated to the position wherein the upper body section is urged away from the lower body section and the step of moving the blade to the second position against the buffer tube guide is accomplished by rotating the cam to allow the tension spring to urge the upper body section toward the lower body section. The cam may include a lever for rotating the cam. The method may include providing a plunger on the upper body section which when the upper body section is toward the lower body section, contacts the buffer tube, slidably securing the buffer tube in the groove.

Another aspect of the present invention is directed to a method for accessing an optical fiber within a buffer tube comprising providing a tool having a body, a buffer tube guide including a groove for insertion of a buffer tube therein, the buffer tool guide removably attached to the tool body, a blade movable from a first position away from the buffer tube guide to a second position against the buffer tube guide and a plunger biased against the groove of the buffer tube guide when the blade is in the second position, wherein the plunger urges the buffer tube into the groove and wherein the blade shaves a portion of the buffer tube when the buffer tube is slid along the groove. The method includes providing a buffer tube having at least one optical fiber therein, ensuring the blade is in the first position away from the buffer tube guide and placing the buffer tube into the buffer tube guide groove along a portion of the buffer tube where the optical fiber is to be accessed. The method includes moving the blade into the second position against the buffer tube guide, pulling the buffer tube along the groove allowing the blade to shave a portion of the buffer tube exposing the optical fibers within the buffer tube, moving the blade into the first position away from the buffer tool guide and removing the buffer tube from the buffer tube guide groove. The removably attached buffer tube may be a first buffer tube and the buffer tube guide is sized for the first buffer tube and the method may include providing a second buffer tube guide which is sized for a second buffer tube different in diameter to the first buffer tube, the method further including selecting the first or second tube guide and securing the selected first or second buffer tube guide to the lower body portion prior to the step of ensuring the blade is in the first position away from the buffer tube guide. The step of moving the blade into the second position against the buffer tube guide may include allowing the plunger to slidingly secure the buffer tube in the groove.

Another aspect of the present invention is directed to a method for accessing an optical fiber within a buffer tube comprising providing a tool having a lower body portion, an upper body portion slidingly attached to the lower body portion, a spring between the lower body portion and the upper body portion biasing the upper body portion away from the lower body portion, a cam lever attached to a cam, the cam lever movable from a first position wherein the upper body portion is disposed away from the lower body portion to a lockable second position wherein the upper body portion is disposed against the lower body portion, a buffer tube guide removably attached to the lower body portion, the buffer tube guide having a groove for placement of a buffer tube therein, a blade disposed on the upper body portion, the blade including a cutting surface disposed at an angle against the buffer tube guide when the cam lever is in the second position and disposed away from the buffer tube guide when the cam lever is in the first position and a plunger disposed on the upper body portion biased against the buffer tube guide channel when the cam lever is in the second position, wherein the buffer tube is axially slidable along the groove when the buffer tube is placed in the groove and wherein the blade shaves a portion of the buffer tube when the cam lever is in the second position and the buffer tube is slid along the groove. The method includes providing a buffer tube having at least one optical fiber therein, ensuring the cam lever is in the first position wherein the upper body portion is disposed away from the lower body portion and placing the buffer tube into the buffer tube guide groove along a portion of the buffer tube where the optical fiber is to be accessed. The method includes moving the cam lever to the second position wherein the upper body portion is disposed against the lower body portion and the plunger urges the buffer tube in the groove, pulling the buffer tube along the groove allowing the blade to shave a portion of the buffer tube exposing the optical fibers within the buffer tube, moving the cam lever to the first position wherein the upper body portion is disposed away from the lower body portion; and removing the buffer tube from the buffer tube guide groove. The buffer tube may be a first buffer tube and the buffer tube guide may be sized for the first buffer tube. The method may include providing a second buffer tube guide which is sized for a second buffer tube different in diameter to the first buffer tube. The method may include selecting the first or second tube guide and securing the selected first or second buffer tube guide to the lower body portion prior to the step of ensuring the blade is in the first position away from the buffer tube guide.

Another aspect of the present invention is directed to a buffer tube shaving tool for accessing an optical fiber within a buffer tube comprising a tool body and buffer tube guide removably attached to the tool body, the buffer tube guide having a groove for insertion of a buffer tube, a blade movable from a first position away from the buffer tube guide to a second position against the buffer tube guide; and a plunger biased against the groove of the buffer tube guide when the blade is in the second position wherein the plunger urges the buffer tube into the groove and wherein the blade shaves a portion of the buffer tube when the buffer tube is slid along the groove.

Another aspect of the present invention is directed to a system for accessing an optical fiber within a buffer tube, the system comprising a lower body portion, an upper body portion slidingly attached to the lower body portion and a compression spring between the lower body portion and the upper body portion biasing the upper body portion away from the lower body portion. The system includes a cam lever attached to a cam, the cam lever movable from a first position wherein the upper body portion is disposed away from the lower body portion to a second position wherein the upper body portion is disposed against the lower body portion. The system includes at least two different buffer tube guides, one of the at least two buffer tube guides attachable to the lower body portion, the buffer tube guides each having a different sized groove for placement of a buffer tube therein. The system includes a blade disposed on the upper body portion, the blade including a cutting surface disposed at an angle against one of the at least two buffer tube guides when the cam lever is in the second position and disposed away from the one of at least two buffer tube guides when the cam lever is in the first position and a plunger disposed on the upper body portion biased against the buffer tube guide groove of the one of at least two buffer tube guides when the cam lever is in the second position. A user may select the one of the at least two buffer tube guides for attachment to the lower body section. The buffer tube is axially slidable along the groove when the buffer tube is placed in the groove. The blade shaves a portion of the buffer tube when the cam lever is in the second position and the buffer tube is slid along the groove. The buffer tube shaving tool may include a tension spring attached at one end to the cam and at the opposite end to the lower body section, wherein the cam is secured to the upper body section, the tension spring urges the upper body section to a position toward the lower body section and the cam, when rotated to the second position, overcomes the tension spring bias to position the upper body section toward the lower body section.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a top left front perspective view of an embodiment of the fiber optic buffer mid-span access shaving tool in the open position according to the present invention.

FIG. 2 is a top right back perspective view of the shaving tool of FIG. 1 in the open position.

FIG. 3 is a front cross sectional view of the shaving tool of FIG. 1 in the open position.

FIG. 4 is a front cross sectional view of the shaving tool of FIG. 1 in the closed position.

FIG. 5 is a top plan view of the shaving tool of FIG. 1 in the open position.

FIG. 6 is a top right front perspective view of the shaving tool of FIG. 1 in the open position.

FIG. 7 is a left elevational view of the shaving tool of FIG. 1 in the closed position.

FIG. 8 is a right elevational view of the shaving tool of FIG. 1 in an open position.

FIG. 9 is a right elevational view of the shaving tool of FIG. 1 in a closed position.

FIG. 10 is a perspective view of the shaving tool of FIG. 1 showing the buffer tube within the groove having a portion shaved to expose the optical fiber.

FIG. 11 is a side view of the shaved buffer tube with a portion of the optical fiber exposed.

FIG. 12 is an end view of the shaved buffer tube with a portion of the optical fiber exposed.

### DESCRIPTION OF THE PREFERRED EMBODIMENT(S)

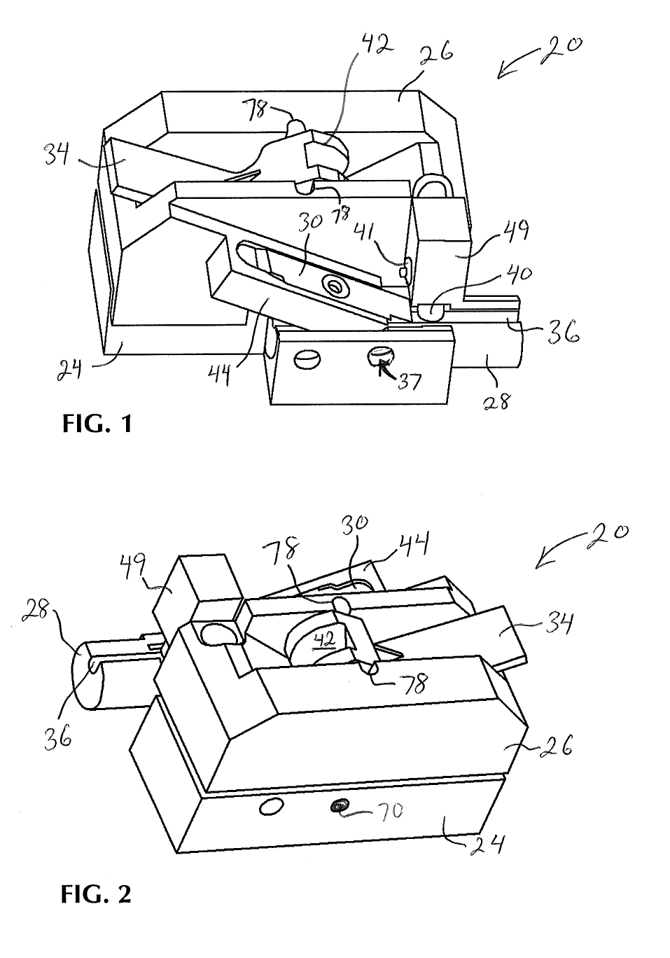

In describing the preferred embodiment of the present invention, reference will be made herein to FIGS. 1-12 of the drawings in which like numerals refer to like features of the invention.

Referring to FIGS. 1-10, the present invention is a fiber optic buffer mid-span shaving tool 20 for accessing the one or more optical fibers within various size buffer tubes. FIGS. 11 and 12 show the optical fiber 23 and buffer tube 22 after a portion of the buffer tube has been removed. The tool 20 for accessing the fiber optic includes a lower body portion 24 and an upper body portion 26 which is slidingly attached to the lower body portion 24. A guide rod 46 is slidingly disposed in an upper body portion guide opening 68 and a lower body portion guide opening 66 so that the upper body portion 26 and lower body portion 24 remain substantially parallel with one another. A compression spring 67 is disposed around a portion of the guide rod 46. Guide openings 66 may include a pocket 63 for a portion of the compression spring 67. The compression spring 67 extends from the pocket closed end 63a to the upper body portion 26, urging the upper body portion 26 away from the lower body portion 24.

A buffer tube guide 28 is removably attached to the lower body portion 24 within a guide opening 95 in the lower body portion 24. The buffer tube guide 28 may be secured by a fastener 37 extending through the lower body portion 24 and the buffer tube guide 28. The fastener 37 may include a spring loaded tip 98 engagable with an indent 99 on the buffer tube guide 28 so the buffer tube guide 28 may be removed by pulling the guide 28 outwardly from the guide opening 95. The buffer tube guide 28 or a second buffer tube guide 28a having a different sized groove 36a may be inserted in the guide opening 95 by pressing the buffer tube guide 28 or the second buffer tube guide 28a firmly into the guide opening 95. The buffer tube guide 28 is semi-cylindrical and has a length l, a first diameter d1, a second diameter d2, a flat surface 29 extending the length of the guide 28. A groove 36 extends the length of the buffer tube guide 28. A lip 27 may extend at least a portion of the length of the buffer tube guide 28. The buffer tube guide 28 is disposed in a guide opening 21 which corresponds to the second diameter d2 portion. A blade 30 is removably attached to a blade holder 44 disposed on the upper body portion 26. A buffer tube pressure pad or plunger 40 is slidingly disposed in a plunger holder 49 on the upper body portion 26 and is biased toward the lower body portion 24 with a plunger spring 50.

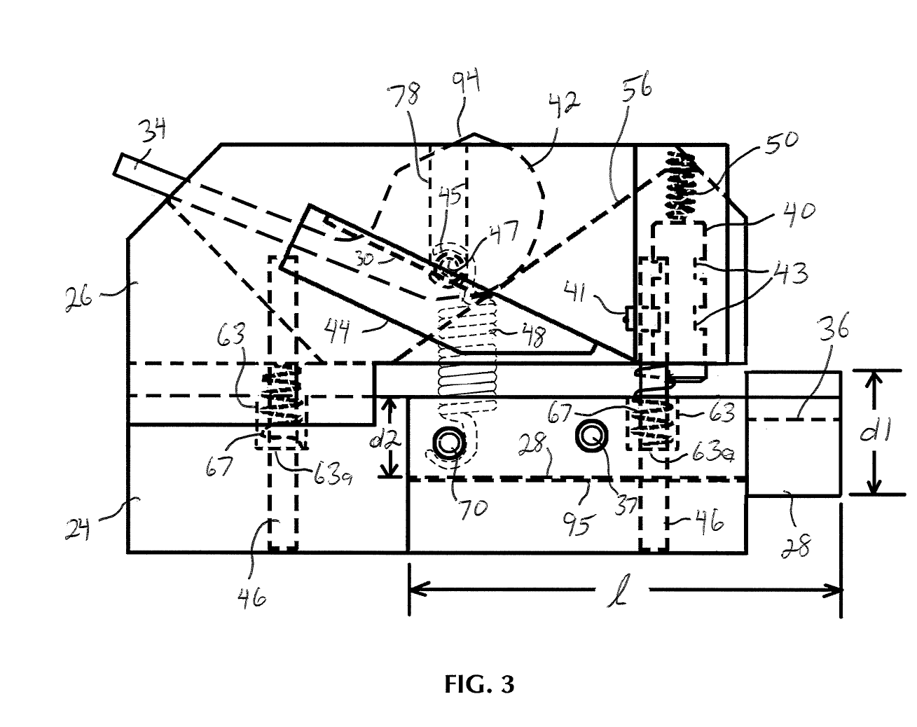

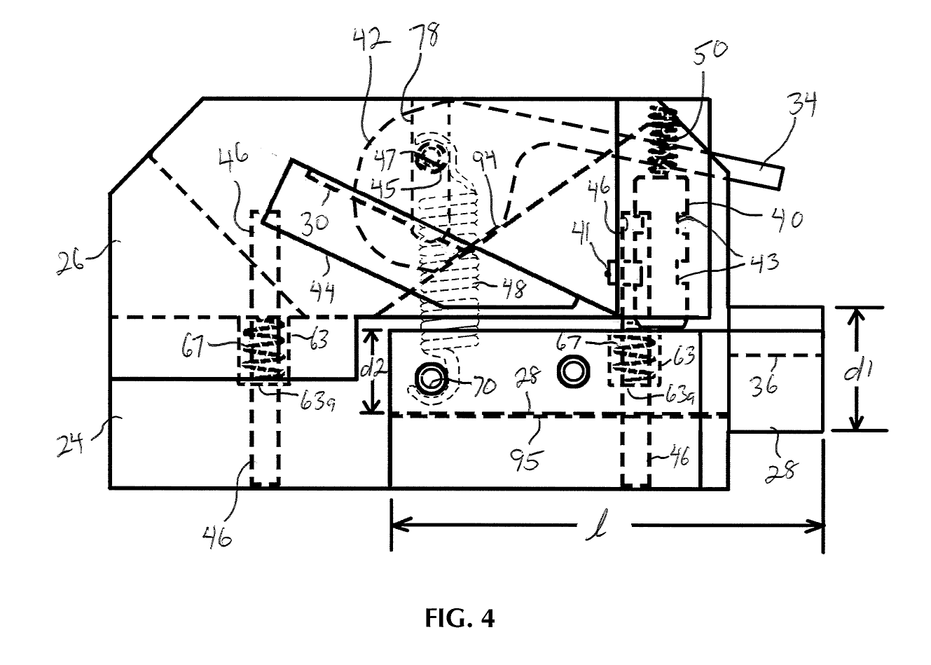

The tool 20 includes a locking cam 42 having a lever 34, pivot opening 45 and pivot pin 47 disposed through the pivot opening 45. The pivot pin 47 is attached to one end of a tension spring 48 and may be slidable within a pair of pivot pin channels 78 extending downwardly from a top surface of the upper body portion 26. The opposite end of the tension spring 48 is secured to a fastener 70 such as a roll pin, the fastener 70 extending through the lower body portion 24. When the cam lever 34 and cam 42 are in the open position (corresponding to the shaving tool being in the open position) as shown in FIG. 3, the cam 42 contacts a ramp 56 on the upper body portion 26, such that the ramp 56 is in close proximity to the pivot opening 45. With the shaving tool 20 in the open position, the compression spring 67 disposed about the guide rod 46 and between the upper body portion 26 and the lower body portion 24 urges the upper body portion 26 away from the lower body portion 24. When the cam lever 34 and cam 42 are in a closed position as shown in FIG. 4, a flat surface 94 on the cam 42 presses against the upper body ramp 56, sliding the pivot pin 47 upwardly in the pivot pin channels 78, putting tension on the tension spring 48 and urging the lower body portion 24 toward the upper body portion. When the cam lever 34 and cam 42 are in the closed position (corresponding to the shaving tool being in the closed position), the cam 42 contacts a ramp 56 on the upper body portion 26, such that the ramp 56 is further from the pivot opening 45 than the close proximity when the shaving tool is in the open position. The flat surface 94 of the cam locks the shaving tool 20 in the closed position since the tension spring 48 urges the flat surface 94 against the ramp 5 on the upper body portion 26. When the cam lever 34 and cam 42 are rotated back to the open position, tension on the tension spring 48 is released, allowing the compression spring 67 to move the upper body portion away from the lower body portion. The tool 20 may include additional guide rods 46 and compression springs 67. The tension spring 48 preferably provides a greater force than the compression spring 67.

The shaving tool allows mid-span access to optical fibers 23 inside a buffer tube 22 by shaving a thin strip 22a from the outer layer of a the buffer tube 22 without damaging fibers 23 within the remaining outer layer 22b. The compression springs 67 keep the tool 20 in an open position to allow quick-load of the buffer tube. The quick-change buffer tube guide 28 allows the operator to change the tool for accepting different sized buffer tubes 22 quickly without the use of a tool or thumb screw to remove the guide 28. The guide 28 includes a groove 36 or channel for the spring loaded plunger 40 located in the upper body portion 24. The groove 36 extends substantially the length of the guide 28. The blade 30 may flex as it contacts the flat surface 29 on the buffer tube guide 28 and the locking cam 34 is rotated to a second position wherein the upper body portion 26 is toward the lower body portion 24. The blade 30 is disposed at an acute angle to the length of the buffer tube 22, for example 25 degrees, and creates a smooth cutting action. The buffer tube pressure pad 32 is spring-loaded and rests on the guide flat surface 29. The plunger 40 compensates for out-of-round and undersize tubes 22 and controls strip width to prevent damaging fibers 23. The cam 34 may be lockable in a position wherein the lower body portion 26 is toward the lower body section 24.

The tool 20 for accessing a fiber optic has the lower body portion 24, the upper body portion 26 slidingly attached to the lower body portion 24 by guide rods 46, and a tension spring 48 between the lower body portion 24 and the upper body portion 26 to bias the upper body portion toward the lower body portion. The cam lever 34 is attached to a cam 42, with the cam lever 34 being movable from a first position wherein the upper body portion 26 is spaced away from the lower body portion 24 to a lockable second position wherein the upper body portion 26 is disposed against the lower body portion 24. The buffer tube guide 28 is removably attached to the lower body portion 24, and the buffer tube guide 28 has a channel or groove 36 for placement of a buffer tube 22 therein. The blade 30 is disposed on a blade holder 44 in the upper body portion 26 and the blade 30 includes a cutting surface disposed at an acute angle against the buffer tube guide 28 when the cam lever 34 is in the second position and spaced away from the buffer tube guide 28 when the cam lever 34 is in the first position. The plunger 40 is disposed on the upper body portion 26 and is biased by spring 46 against the buffer tube 22 in the guide channel 36 when the cam lever 34 is in the second position. A plunger lock 41 may secure the plunger 40 in a plunger block 42 by engaging plunger detents 43 with the plunger 40 in an upper or lower position.

As shown in FIG. 9, the buffer tube 22 is axially slideable along the groove 36 when the buffer tube 22 is placed in the groove 36. The blade 30 shaves a portion 22a of the buffer tube 22 when the cam lever 34 is in the second position and the buffer tube 22 is slid along the groove 36, leaving a portion 22b of the buffer tube 22 along the shaved section of the buffer tube 22.

In the method of operating the tool for accessing an optical fiber within a buffer tube, a user provides the buffer tube having at least one optical fiber therein. The user then ensures that the cam lever is in the first position wherein the upper body portion is spaced away from the lower body portion. The user then places the buffer tube into the buffer tube guide groove along a portion of the buffer tube where the optical fiber is to be accessed. The user then moves the cam lever to the second position wherein the upper body portion is disposed against the lower body portion and the plunger urges the buffer tube in the groove. The user pulls the buffer tube along the groove allowing the blade to shave a portion of the buffer tube exposing the optical fibers within the buffer tube. The user then moves the cam lever to the first position wherein the upper body portion is disposed away from the lower body portion and removes the buffer tube from the buffer tube guide groove with the desired portion of the tube removed to access an optical fiber within.

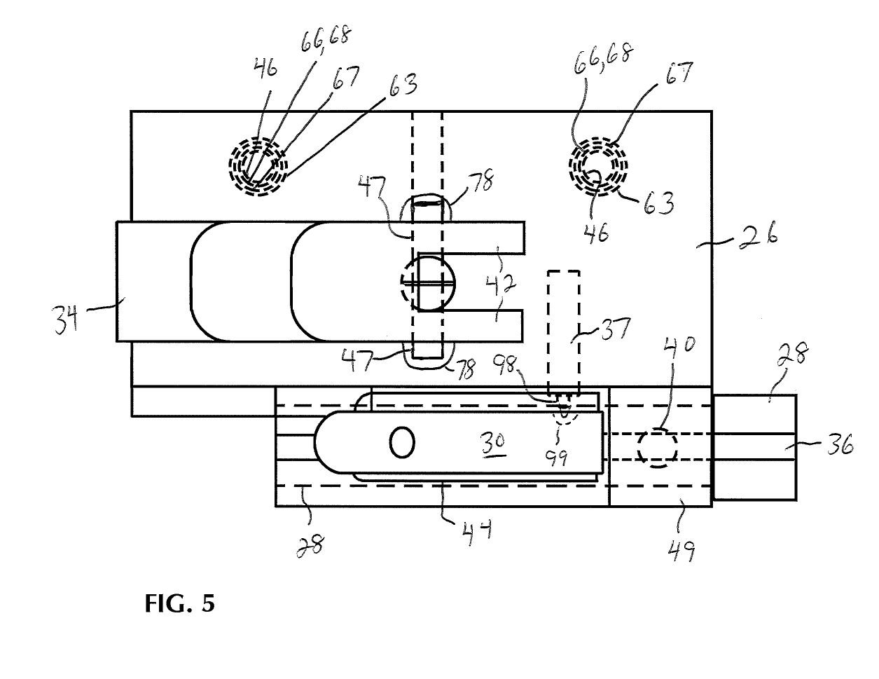

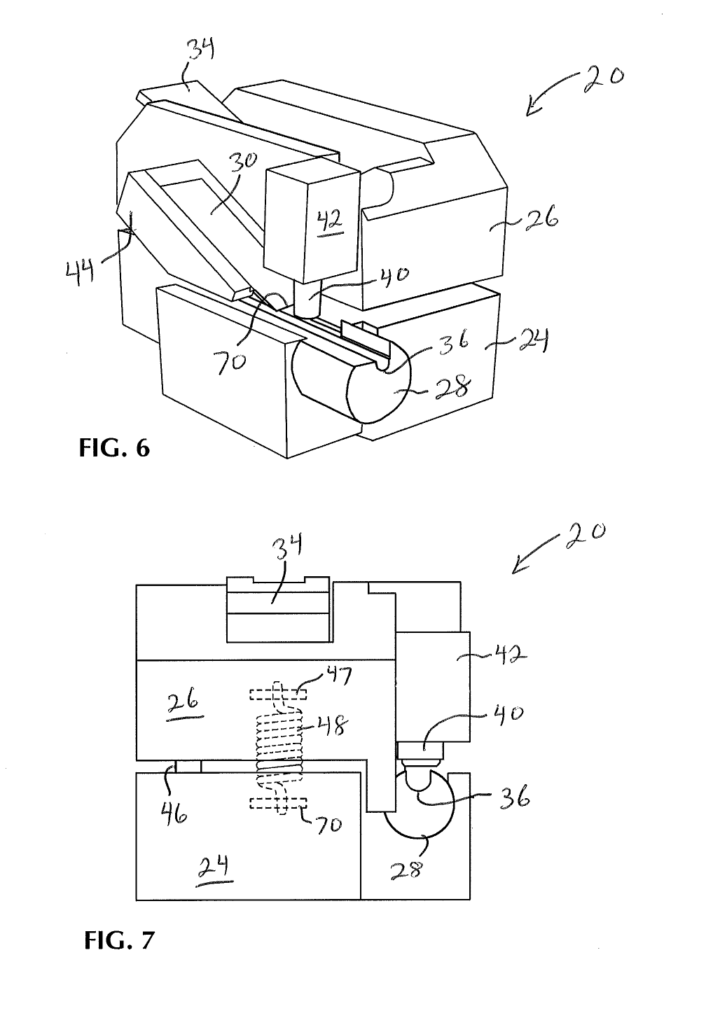

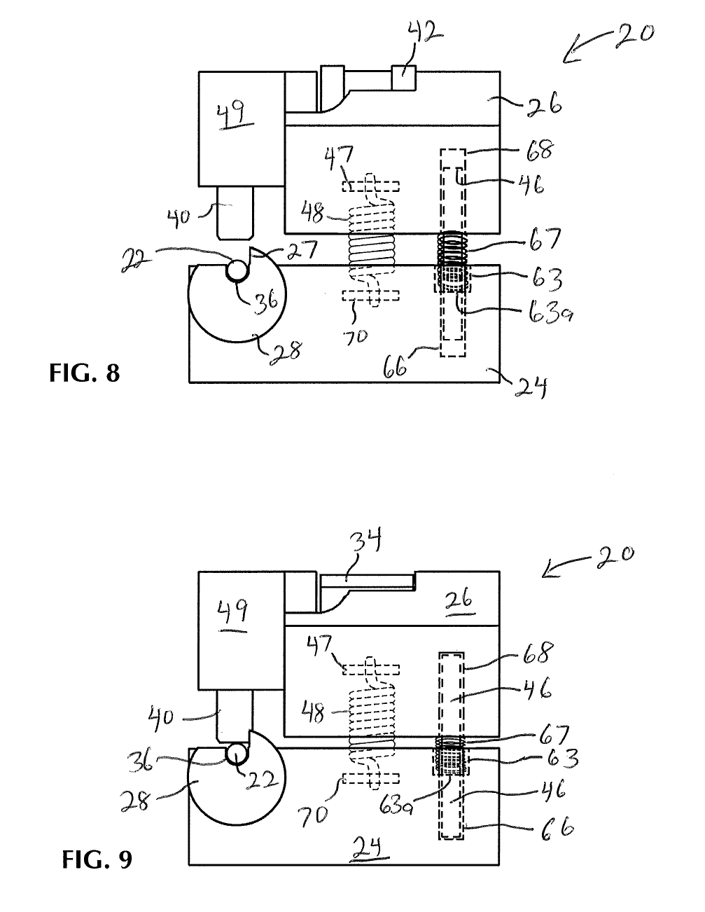

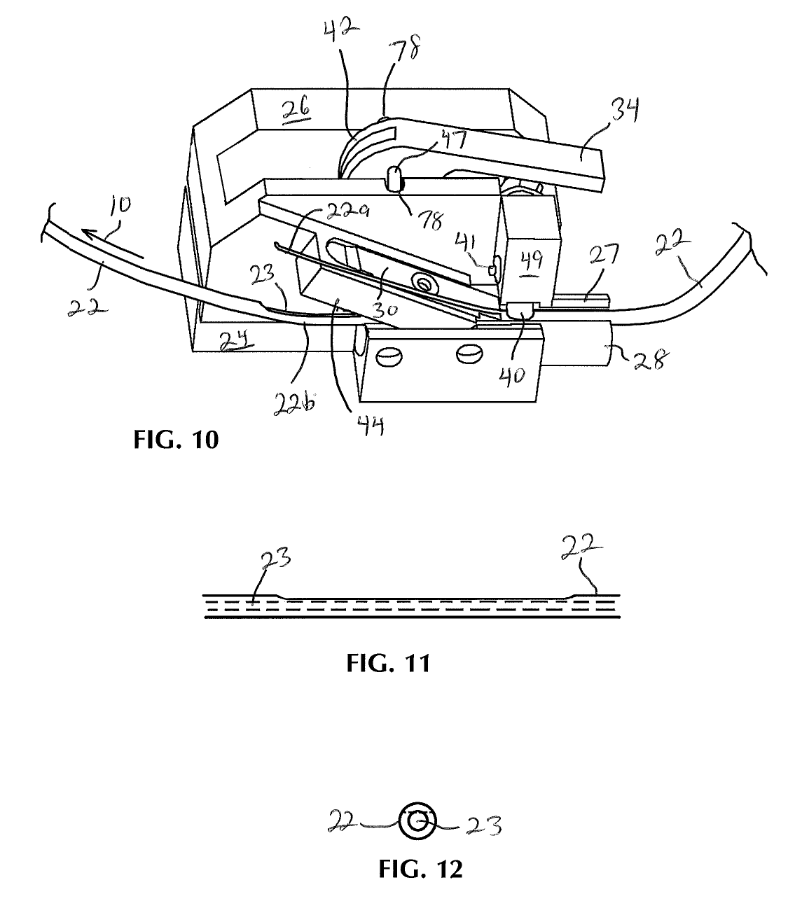

In another aspect, the method for accessing an optical fiber within a buffer tube is shown in FIG. 8 and referring the open and closed positions shown in FIGS. 5 and 6. The tension spring between the lower body portion and the upper body portion biases the upper body portion toward the lower body portion. The cam lever 34 is attached to a cam 42 and is movable from a first position wherein the upper body portion 26 is disposed away from the lower body portion 24 to a second position wherein the upper body portion 26 is disposed toward or against the lower body portion 24. The lever 34 first position and second position correspond with a cam 42 first position and second position, respectively. The buffer tube guide 28 is removably attached to the lower body portion 24. The buffer tube guide includes a groove 36 for placement of a buffer tube 22. The blade 30 is disposed on a blade holder 44 which is attached to the upper body portion 26. The blade 30 includes a cutting surface 70 disposed at an angle against the buffer tube guide 28 when the cam lever 34 is in the second position and disposed away from the buffer tube guide 28 when the cam lever 34 is in the first position and the plunger 40 is disposed within the plunger block 42. The plunger block 42 is attached to the upper body portion 26 and the plunger 40 biased against the buffer tube guide groove 36 when the cam lever 34 is in the second position. The buffer tube 22 is axially slidable along the groove 36 when the buffer tube 22 is placed in the groove 36. The cam lever 34 is moved to a position wherein the upper body portion 26 is disposed against the lower body portion and the plunger urges the buffer tube in the groove. When the blade 30 is in the lowered position and the buffer tube is pulled in the direction of the arrow 10, the blade cutting surface 70 shaves a portion of the buffer tube 22. The method includes pulling the buffer tube along the groove allowing the blade to shave a portion of the buffer tube exposing the optical fibers within the buffer tube. The cam lever 34 is then moved to the first position wherein the upper body portion 26 is disposed away from the lower body portion 24. The buffer tube 22 is then removed from the buffer tube guide groove 36. The removably attached buffer tube 28 may be replaced with a different buffer tube 28a sized with a larger or smaller diameter groove 36a. The method then includes selecting the desired sized tube guide 22, 22a and securing the desired buffer tube guide 22, 22a to the lower body portion 24 prior to the step of ensuring the blade 30 is in the position away from the buffer tube guide 28. FIGS. 9 and 10 show the buffer tube 22 and the optical cable 23 exposed after the method has been employed.

The fiber optic buffer mid-span access shaving tool of the present invention achieves the above-described objects and creates a mid-span access opening in fiber optic buffer tubes without damaging fibers. The tool has one or more of the following advantages: 1) the guide groove or channel and pressure pad or plunger compensate for out-of-round buffer tubes, 2) the quick-change guide design eliminates need for the tool or a thumb screw to change guide size, 3) the spring-loaded body keeps the tool in open position for tube loading, 4) the locking cam keeps the tool in locked position during use and 5) the blade design with preferably a 25-degree angle creates smooth cutting action without damage to the underlying fibers.

The object of the present invention have been achieved with the described tool including providing a tool and method for accessing an optical fiber within a buffer tube to create a mid-span access opening in fiber optic buffer tubes without damaging fibers, providing a tool and method that compensates for out-of-round buffer tubes, providing a tool and method that eliminates the need for tool or thumbscrew to change guide size, and providing a tool and method that keeps the tool in open position to make tube loading quick and easy. The present invention also provides a tool method that keeps the tool in locked position during use, provides a tool and method with a blade design that creates smooth cutting action of the buffer tube without disturbing or damaging the underlying fibers and provides a tool in which there is no need for the operator to adjust the setting of the blade.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A buffer tube shaving tool for accessing an optical fiber within a buffer tube comprising:
a buffer tube guide having a groove for insertion of a buffer tube; and
a blade movable from a first position away from the buffer tube guide to a second position against the buffer tube guide.

2. The buffer tube shaving tool according to claim 1 including a lower body section and an upper body section movable toward and away from the lower body section, the blade attached to the upper body section and the buffer tube guide attached to the lower body section wherein the blade contacts the buffer tube when the upper body section is toward the lower body section.

3. The buffer tube shaving tool according to claim 2 wherein the buffer tube guide is removably securable to the lower body section and the buffer tube guide is replaceable with at least one different sized buffer tube guide for insertion of at least one different sized buffer tube.

4. The buffer tube shaving tool according to claim 2 including a tension spring which urges the upper body section to a position toward the lower body section.

5. The buffer tube shaving tool according to claim 4 including a cam having a pivot attached to one end of the tension spring, the opposite end of the tension spring attached to the lower body section wherein in a first cam position the upper body section moves away from the lower body section and in a second cam position, the cam provides tension on the tension spring, urging the upper body section toward the lower body section.

6. The buffer tube shaving tool according to claim 2 including:
an oval cam having a short diameter, a long diameter, a pivot positioned perpendicular to the short diameter and the long diameter;
a cam lever attached to the cam for rotating the cam between a horizontal direction wherein the short diameter extends between the upper body section and the lower body section and a vertical direction wherein the long diameter extends between the upper body section and the lower body section.

7. The buffer tube shaving tool according to claim 6 including:
a tension spring attached at one end to a pivot on the cam and at the opposite end to the lower body section, the tension spring urging the upper body section to a position toward the lower body section when the cam is in the vertical direction;
wherein the pivot on the cam is rotatingly secured to the upper body section.

8. The buffer tube shaving tool according to claim 7 wherein the pivot is perpendicular to the cam short diameter and cam long diameter.

9. The buffer tube shaving tool according to claim 2 including at least one guide rod slidingly disposed at one end in an upper body section opening and at the opposite end in a lower body section opening whereby the upper body section remains parallel to the lower body section as the upper body section moves toward or away from the lower body section.

10. The buffer tube shaving tool according to claim 2 including a plunger on the upper body section which when the upper body section is toward the lower body section, contacts the buffer tube, slidably securing the buffer tube in the groove.

11. The buffer tube shaving tool according to claim 10 including a plunger holder and a plunger spring disposed in an elongated opening in the plunger holder, the plunger disposed against the plunger spring wherein the plunger is urged against the buffer tube by the plunger spring.

12. The buffer tube shaving tool according to claim 2 including a cam lever attached to a cam, the cam lever movable from a first position wherein the upper body portion is disposed away from the lower body portion to a lockable second position wherein the upper body portion is disposed against the lower body portion.

13. The buffer tube shaving tool according to claim 1 including a blade holder for securing the blade in either the blade first position or the blade second position.

14. The buffer tube shaving tool according to claim 2 including a blade holder for securing the blade on the upper body section.

15. A buffer tube shaving tool for accessing an optical fiber within a buffer tube, the tool comprising:
a lower body portion;
an upper body portion slidingly attached to the lower body portion;
a compression spring between the lower body portion and the upper body portion biasing the upper body portion away from the lower body portion;
a cam lever attached to a cam, the cam lever movable from a first position wherein the upper body portion is disposed away from the lower body portion to a second position wherein the upper body portion is disposed against the lower body portion;
a buffer tube guide attached to the lower body portion, the buffer tube guide having a groove for placement of a buffer tube therein;
a blade disposed on the upper body portion, the blade including a cutting surface disposed at an angle against the buffer tube guide when the cam lever is in the second position and disposed away from the buffer tube guide when the cam lever is in the first position; and
a plunger disposed on the upper body portion biased against the buffer tube guide groove when the cam lever is in the second position;
wherein the buffer tube is axially slidable along the groove when the buffer tube is placed in the groove; and
wherein the blade shaves a portion of the buffer tube when the cam lever is in the second position and the buffer tube is slid along the groove.

16. The buffer tube shaving tool according to claim 15 including a tension spring attached at one end to the cam and at the opposite end to the lower body section, wherein the cam is secured to the upper body section, the tension spring urges the upper body section to a position toward the lower body section and the cam, when rotated to the second position, overcomes the tension spring bias to position the upper body section toward the lower body section.

17. A method for accessing an optical fiber within a buffer tube comprising:
providing a buffer tube guide having a groove for insertion of a buffer tube and a blade movable from a first position away from the buffer tube guide to a second position against the buffer tube guide;
providing a buffer tube having an optical fiber therein;
ensuring the blade is in the first position away from the buffer tube guide;
placing the buffer tube in the groove of the buffer tube guide;
moving the blade to the second position against the buffer tube guide;
sliding the buffer tube in the groove until a portion of the buffer tube has been removed by the blade;
moving the blade to the first position away from the buffer tube guide; and
removing the buffer tube from the buffer tube guide.

18. The method according to claim 17 including;
providing a lower body section and an upper body section movable toward and away from the lower body section, the blade attached to the upper body section and the buffer tube guide attached to the lowered body section wherein the blade contacts the buffer tube when the upper body section is toward the lower body section, wherein the step of ensuring the blade is in the first position away from the buffer tube guide includes ensuring that the upper body section is in the position away from the lower body section and the step of moving the blade to the first position away from the buffer tube guide includes moving the upper body section away from the lower body section.

19. The method according to claim 18 including:
providing a compression spring which urges the upper body section to a position away from the lower body section; and
providing a cam which urges the upper body section toward the lower body section; wherein
the step of ensuring that the upper body section is in the position away from the lower body section is accomplished by ensuring the cam is rotated to the position wherein the upper body section is urged away from the lower body section and the step of moving the blade to the second position against the buffer tube guide is accomplished by rotating the cam to urge the upper body section toward the lower body section.

20. The method of claim 19 wherein the cam includes a lever for rotating the cam.

21. The method of claim 17 including providing a plunger on the upper body section which when the upper body section is toward the lower body section, contacts the buffer tube, slidably securing the buffer tube in the groove.

22. A method for accessing an optical fiber within a buffer tube comprising:
providing a tool having a body, a buffer tube guide including a groove for insertion of a buffer tube therein, the buffer tool guide attached to the tool body, a blade movable from a first position away from the buffer tube guide to a second position against the buffer tube guide and a plunger biased against the groove of the buffer tube guide when the blade is in the second position, wherein the plunger urges the buffer tube into the groove and wherein the blade shaves a portion of the buffer tube when the buffer tube is slid along the groove;
providing a buffer tube having at least one optical fiber therein;
ensuring the blade is in the first position away from the buffer tube guide;
placing the buffer tube into the buffer tube guide groove along a portion of the buffer tube where the optical fiber is to be accessed;
moving the blade into the second position against the buffer tube guide;
pulling the buffer tube along the groove allowing the blade to shave a portion of the buffer tube exposing the optical fibers within the buffer tube;
moving the blade into the first position away from the buffer tool guide; and
removing the buffer tube from the buffer tube guide groove.

23. The method of claim 22 wherein the removably attached buffer tube is a first buffer tube and the buffer tube guide is sized for the first buffer tube and the method includes providing a second buffer tube guide which is sized for a second buffer tube different in diameter to the first buffer tube, the method further including selecting the first or second tube guide and securing the selected first or second buffer tube guide to the lower body portion prior to the step of ensuring the blade is in the first position away from the buffer tube guide.

24. The method of claim 22 including allowing the plunger to slidingly secure the buffer tube in the groove prior to the step of pulling the buffer tube along the groove.

25. A method for accessing an optical fiber within a buffer tube comprising:
providing a buffer tube shaving tool having a lower body portion, an upper body portion slidingly attached to the lower body portion, a spring between the lower body portion and the upper body portion biasing the upper body portion away from the lower body portion, a cam lever attached to a cam, the cam lever movable from a first position wherein the upper body portion is disposed away from the lower body portion to a lockable second position wherein the upper body portion is disposed against the lower body portion, a buffer tube guide removably attached to the lower body portion, the buffer tube guide having a groove for placement of a buffer tube therein, a blade disposed on the upper body portion, the blade including a cutting surface disposed at an angle against the buffer tube guide when the cam lever is in the second position and disposed away from the buffer tube guide when the cam lever is in the first position and a plunger disposed on the upper body portion biased against the buffer tube guide groove when the cam lever is in the second position, wherein the buffer tube is axially slidable along the groove when the buffer tube is placed in the groove and wherein the blade shaves a portion of the buffer tube when the cam lever is in the second position and the buffer tube is slid along the groove;
providing a buffer tube having at least one optical fiber therein;
ensuring the cam lever is in the first position wherein the upper body portion is disposed away from the lower body portion;
placing the buffer tube into the buffer tube guide groove along a portion of the buffer tube where the optical fiber is to be accessed;
moving the cam lever to the second position wherein the upper body portion is disposed against the lower body portion and the plunger urges the buffer tube in the groove,
pulling the buffer tube along the groove allowing the blade to shave a portion of the buffer tube exposing the optical fibers within the buffer tube;
moving the cam lever to the first position wherein the upper body portion is disposed away from the lower body portion; and
removing the buffer tube from the buffer tube guide groove.

26. The method of claim 25 wherein the buffer tube is a first buffer tube and the buffer tube guide is sized for the first buffer tube and the method includes providing a second buffer tube guide which is sized for a second buffer tube different in diameter to the first buffer tube, the method further including selecting the first or second tube guide and securing the selected first or second buffer tube guide to the lower body portion prior to the step of ensuring the blade is in the first position away from the buffer tube guide.

27. A buffer tube shaving tool for accessing an optical fiber within a buffer tube comprising:
a tool body and buffer tube guide removably attached to the tool body, the buffer tube guide having a groove for insertion of a buffer tube;
a blade movable from a first position away from the buffer tube guide to a second position against the buffer tube guide; and
a plunger biased against the groove of the buffer tube guide when the blade is in the second position wherein the plunger urges the buffer tube into the groove and wherein the blade shaves a portion of the buffer tube when the buffer tube is slid along the groove.

28. A system for accessing an optical fiber within a buffer tube, the system comprising:
a lower body portion;
an upper body portion slidingly attached to the lower body portion;
a compression spring between the lower body portion and the upper body portion biasing the upper body portion away from the lower body portion;
a cam lever attached to a cam, the cam lever movable from a first position wherein the upper body portion is disposed away from the lower body portion to a second position wherein the upper body portion is disposed against the lower body portion;
at least two different buffer tube guides, one of the at least two buffer tube guides attachable to the lower body portion, the buffer tube guides each having a different sized groove for placement of a buffer tube therein;
a blade disposed on the upper body portion, the blade including a cutting surface disposed at an angle against one of the at least two buffer tube guides when the cam lever is in the second position and disposed away from the one of at least two buffer tube guides when the cam lever is in the first position; and
a plunger disposed on the upper body portion biased against the buffer tube guide groove of the one of at least two buffer tube guides when the cam lever is in the second position;
wherein a user selects the one of the at least two buffer tube guides for attachment to the lower body section;
wherein the buffer tube is axially slidable along the groove when the buffer tube is placed in the groove; and
wherein the blade shaves a portion of the buffer tube when the cam lever is in the second position and the buffer tube is slid along the groove.

29. The buffer tube shaving tool according to claim 15 including a tension spring attached at one end to the cam and at the opposite end to the lower body section, wherein the cam is secured to the upper body section, the tension spring urges the upper body section to a position toward the lower body section and the cam, when rotated to the second position, overcomes the tension spring bias to position the upper body section toward the lower body section.
